(19) United States
(12) Patent Application Publication
(10) Pub. No.: US 2015/0292893 A1
(43) Pub. Date: Oct. 15, 2015

(54) METHOD FOR PROVIDING PREDICTIVE TARGET POSITIONS AND/OR PREDICTIVE ROUTES TO ACHIEVE A TARGET POSITION AND NAVIGATION SYSTEM

(71) Applicants: VOLKSWAGEN AG, Wolfsburg (DE); AUDI AG, Ingolstadt (DE)

(72) Inventors: Patrick BARTSCH, Wolfsburg (DE); Kathrin WILKENS, Wolfsburg (DE); Simon GERLACH, Meine (DE)

(21) Appl. No.: 14/682,729

(22) Filed: Apr. 9, 2015

(30) Foreign Application Priority Data
Apr. 9, 2014 (EP) 14164053.2-1557

(51) Int. Cl. G01C 21/34; G01C 21/36

(52) U.S. Cl. CPC G01C 21/34; G01C 21/36; G01C 21/3492

(57) ABSTRACT

A method for providing predictive destination positions and/or predictive routes for reaching a destination position, in which the current local position is ascertained and the destination position is automatically derived according to probability aspects on the basis of a comparison between stored driving information from the past and current driving information, wherein n possible destination positions are ascertained, where n≧2, with the destination position being offered as an input option for a navigation system and/or the predictive routes with the destination positions being presented simultaneously. Also disclosed is a navigation system.

### PRIORITY CLAIM

This patent application claims priority to European Patent Application No. 14164053.2-1557, filed 9 Apr. 2014, the disclosure of which is incorporated herein by reference in its entirety.

### SUMMARY

Illustrative embodiments relate to a method for providing predictive destination positions and/or predictive routes for reaching a destination position and to a navigation system.

Illustrative embodiments provide a method for providing predictive destination positions and/or predictive routes for reaching a destination position and provide a navigation system that is more user friendly and provides better support for a user.

### BRIEF DESCRIPTION OF THE DRAWINGS

The invention is explained in more detail below with reference to an exemplary embodiment. In the figures:

FIG. 1 shows a schematic block diagram of a navigation system;

FIG. 2 shows an exemplary presentation on a display unit for possible destination positions and predictive routes; and

FIG. 3 shows an exemplary presentation for selection of a predictive route.

### DETAILED DESCRIPTION OF THE DISCLOSED EMBODIMENTS

The method for providing predictive destination positions and/or predictive routes for reaching a destination position has the method steps that the current local position is ascertained and the destination position is automatically derived according to probability aspects on the basis of a comparison between stored driving information from the past and current driving information, wherein n possible destination positions are ascertained, where n≧2, with the destination positions being offered as an input option for a navigation system and/or the predictive routes with the destination positions being presented simultaneously. The basic concept in this case is that the approach to the solution from the prior art, ascertaining a single predictive route as accurately as possible, frequently leads to frustration for the user. If many potential destination positions are situated close together, it is relatively late before just a very high probability is achieved. Furthermore, the frustration is even greater if the single selected destination position is also incorrect. At least two destination positions and/or routes are therefore presented, and conversely n should also not be chosen to be too great. Optionally, 2≦n ≦10, additionally optionally, 2≦n≦5. A very good compromise in this case is n=3.

Provision may be made for only the potential destination positions with the highest probability to be offered at first, for example, in a list. Regardless of the form of presentation, the destination positions can be sorted according to their probability in this case. Provision may then be made for selection of a destination position to prompt the predictive route selected in this manner to be computed as an input for the navigation system or to be adopted from the driving information. Similarly, it is alternatively or cumulatively possible for provision to be made for the predictive routes themselves to be displayed, with the user being able to select one when needed.

The presentation of the predictive routes with the destination positions can be effected very differently. By way of example, the predictive routes can be presented in a 2D map presentation and/or in a list. In addition, provision may be made for the predictive routes to be presented in a list first of all, with selection of a predictive route from the list prompting this selected predictive route to be provided in a 2D map presentation. In addition, provision may be made for the predictive routes to be presented in a 2D map presentation, with only the destination positions and possibly intermediate destinations being presented in list form. In this case it should be noted that the presentation in list form is an alpha numeric presentation.

In principle, it is also conceivable for the destination positions also to be ascertained without driving information from the past, but incorrect associations then increase.

In at least one disclosed embodiment, the current local position is ascertained continuously, with the destination positions and/or routes being continuously tracked on the basis of the change in the local position. By way of example, the motor vehicle first of all moves from point A to B, with n1-n3 being the most probable destination positions. If the user then does not select a destination position, and it is to move toward C, the probability of the destination positions changes and n3-n5 are displayed, for example. As a result, the probability of offering the user the desired destination position increases.

In a further disclosed embodiment, the stored driving information from the past has intermediate destinations that are taken into account for computing the predictive route or routes. By way of example, an intermediate destination of this kind may be a regular intermediate stop (such as a bakery on the way to work, for example). This increases the probability of estimating a route that the user actually intends to take.

However, it is not imperative to store the intermediate destinations for the stored driving information from the past as intermediate destinations to take them into account for the predictive routes. By way of example, provision may be made for a route to be deemed completed when the ignition is turned off (or in the event of a comparable operational signal in the case of an electric vehicle) and then to be stored as driving information from the past. When the motor vehicle is restarted from the intermediate destination to the actual destination position, a route is then recorded again and stored for the driving information from the past. When the motor vehicle driver then drives off in the morning, for example, he is offered the route to the intermediate destination (e.g. bakery) and an alternative route to his job as at least one predictive route. If the motor vehicle driver then selects the route to the intermediate destination, this route is presented. When the motor vehicle driver then restarts from the intermediate destination, he is presented with at least the route from the intermediate destination to his job as a predictive route.

The way in which these intermediate stops or intermediate destinations are taken into account is thus dependent on how the criterion for a completed route is chosen, inter alia.

It should be noted that navigation on the predictive route can also be effected silently (without maneuver announcements). Optionally, this can be set by the user. In this case, provision may also be made for particular events to be able to automatically prompt changeover from silent navigation to maneuver announcements.

In a further disclosed embodiment current traffic reports are associated with a possible destination position and/or a predictive route. In this case, it should be noted that a current traffic report may also be such an event to change over to maneuver announcements.

The traffic information may be taken into account continuously, so that effects on a route are presented to the user continuously and particular system reactions are initiated, such as updating the arrival time and/or warning the user, for example. The type of warning may be very different in this case.

By way of example, provision may be made for a warning to be output to the user (e.g. a popup, a voice output) if there is a traffic disruption for the currently most probable route (or for a route whose probability is greater than the particular threshold value), which traffic disruption delays the arrival time on this route by more than a predetermined time (e.g. 5 minutes). Hence, the user is intended to have the possible problem pointed out even if he has not yet been in the navigation menu or has not paid attention to the display unit, for example.

In a further disclosed embodiment, an alternative route to a destination is computed or computation is offered, as a result of which the user generally has a greater degree of freedom and specifically is provided with assistance to bypass accident spots or queues, for example, by means of the traffic reports. Optionally, provision is made for alternative routes to be immediately displayed to the user when a route is selected for which it is already known at this time that there is traffic disruption.

In a further disclosed embodiment, the routes and/or alternative routes are computed taking into account set and/or previously stored driver preferences. Such driver preferences may be “avoid toll roads”, “no ferries”, “shortest route” or “fastest route”, for example.

Additionally or alternatively, the alternative routes can also be derived from the driving information from the past.

The navigation system for providing predictive destination positions and/or predictive routes for reaching a destination position comprises a computation unit having a database, a display unit, means for capturing a local position and a memory having driver information from the past, wherein the navigation system is in a form such that the current local position is ascertained and the destination position is automatically derived according to probability aspects on the basis of a comparison between the stored driving information from the past and current driving information (e.g. direction of the vehicle movement), wherein the navigation system is in a form such that n possible destination positions are ascertained, where n≧2, with the destination positions being offered as an input option for the navigation system and/or the predictive routes with the destination positions being presented simultaneously on the display unit. In this case, it should be noted that n does not have to be constant, but rather can change according to the situation. Thus, situations are also conceivable where n=1, since only one destination position is probable.

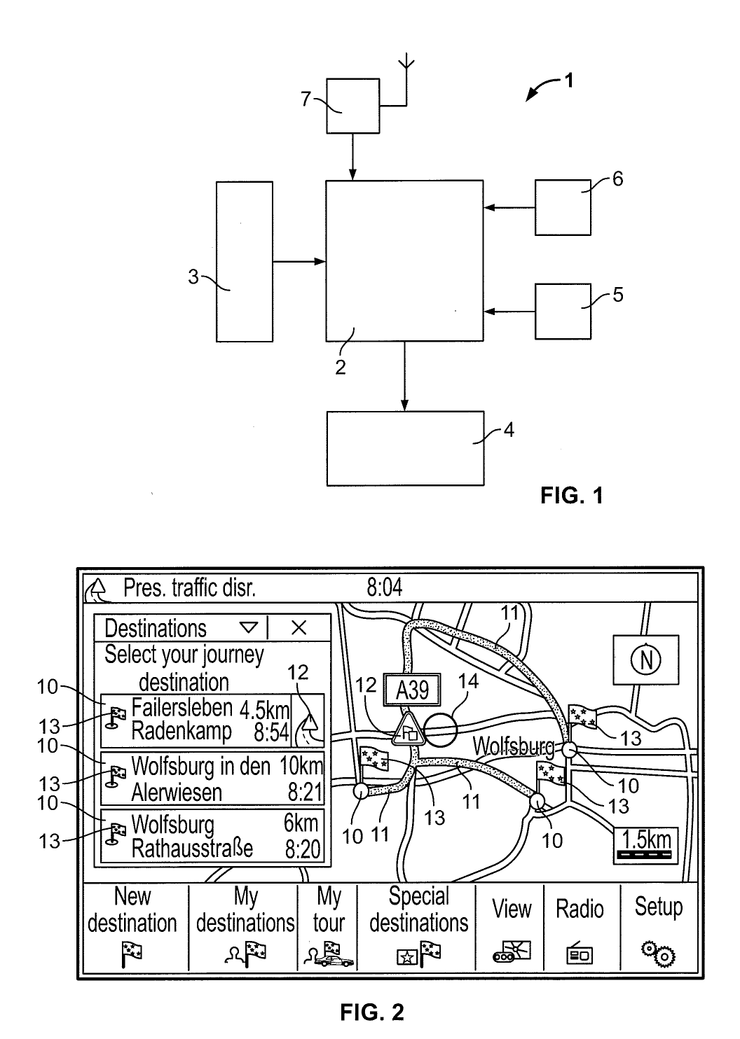

FIG. 1 shows a schematic block diagram of a navigation system 1, comprising a computation unit 2 having a database 3, a display unit 4, at least one means 5 for capturing a local position and a memory 6 containing driver information from the past. In addition, a module 7 is shown that can be used to receive traffic information and to forward it to the computation unit 2. By way of example the module 7 is a GSM module. The means 5 are a GPS receiver, for example. The database 3 is a digital road map, for example, and the database 3 can also be arranged in the computation unit 2. The memory 6 stores routes and/or destination positions that have been taken/visited in the past. These routes and/or destination positions may be routes and/or input destination positions that have been computed by means of the navigation system in the past. Alternatively or cumulatively, they are routes and/or destination positions that have been taken/visited without navigation and have been stored. In this case, the routes and/or destination positions may have associated frequencies and/or other parameters, such as time of day and day of the week. Furthermore, the routes have associated intermediate destinations (if existent).

When the motor vehicle now drives off without a destination position having been input into the navigation system 1 (for example, using a touchscreen display unit), the current local position of the motor vehicle is first of all ascertained. A plurality of local positions are then recorded in succession over a certain previously stipulated distance (e.g. 1 kilometer) and an extent of match between this distance and portions of recorded routes is ascertained from the driver information from the past. This extent of match may be ascertained using the intervals between the individual recorded local positions for the recorded routes. From the individual intervals, a total extent is then ascertained using a mathematical method (e.g. sum, average, median, etc.). Besides the intervals, the current time and date are additionally also compared with the repetition pattern for the historic route and taken into account for ascertaining the most probable route.

As a result, possible (predictive) destination positions 10 and predictive routes 11 are ascertained by the computation unit 2 and presented on the display unit 4. In addition, length and estimated arrival time are also associated with the respective destination position 10. If traffic information exists that relates to a route 11 to a destination position 10, it is likewise associated with the destination position 10 and the route 11, for example, as a pictogram 12. When the pictogram 12 is selected, the user is provided with detailed information about the traffic information. The list of predictive destination positions 10 can be sorted according to probability in this case. In the list, the destination positions 10 are presented alphanumerically. In addition, the predictive routes 11 are presented in a 2D map presentation. In this case, the predictive routes 11 can be presented in different colors by way of example. In addition, provision may be made for the destination positions 10 in the list to have a color that corresponds to the associated route 11. In the example shown, all three (n=3) destination positions 10 are identified by a destination flag 13. In this case, the destination flag 13 is presented as the destination position 10 both in the presentation of the destination positions 10 in list form and in the presented route 11.

Provision may also be made for the destination flags 13 to be in a different form for the different destinations positions 10, thus facilitating the association between the destination position 10 in list form and destination positions presented in the map. In addition, the current local position is identified by a circle 14 or the like in the 2D map. At the bottom edge of the display unit 4, the user is offered alternative input options, which will not be considered in more detail at this juncture.

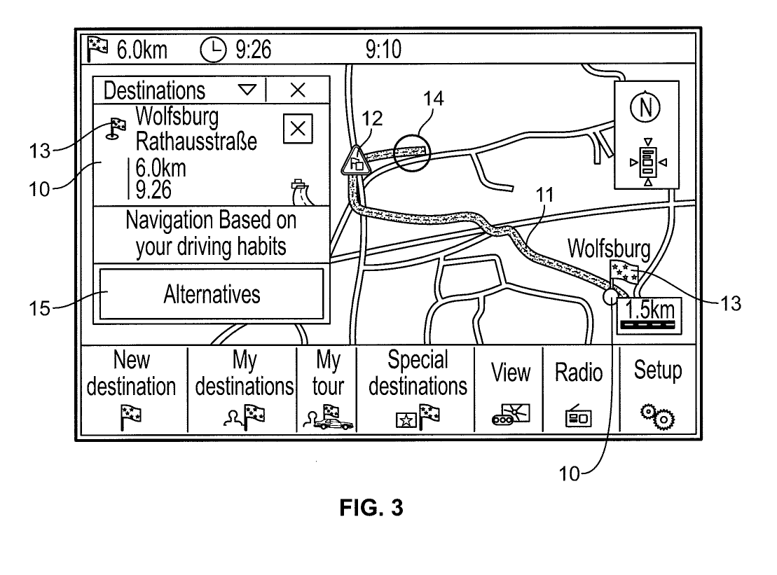

If the user now selects a destination position 10 or a predictive route 11 (e.g. by touch), the presentation shown in FIG. 2 changes to a presentation as shown in FIG. 3. In the latter presentation, only the selected predictive route is now displayed in the 2D map presentation. In addition, the selected destination position 10 is provided with an input panel 15 to compute one or more alternative routes to the destination position 10.

Illustrative embodiments relate to a method for providing predictive destination positions and/or predictive routes for reaching a destination position and to a navigation system.

DE 195 35 576 A1 discloses a method for navigation support for a vehicle driver for the purpose of reaching a destination position with a vehicle that involves the current local position being ascertained, a journey route being determined and current driving directions for this journey route being fetched from a traffic computer arranged outside the vehicle and displayed to the driver, with the destination position being automatically derived according to probability aspects on the basis of a comparison between stored driving information from the past and current driving information. To minimize erroneous driving direction displays, a match with a journey route or route section in a standard journey route memory is assumed only if there is a very high probability of 95%, for example. As an alternative to automatic adoption of a journey route, it is proposed that the ascertained destination position needs to be confirmed by the driver, for example, when services that are subject to a fee are used. For the ascertainment of probability, it is also possible to take into account the day of the week and/or the time of day.

A similar method for an onboard system is known from WO 2007/087928 A1.

1. A method for providing predictive destination positions and/or predictive routes for reaching a destination position, the method comprising:
ascertaining a current local position; and
automatically deriving the destination position according to probability aspects based on a comparison between stored driving information from the past and current driving information,
wherein n possible destination positions are ascertained, where n≧2, with the destination position being offered as an input option for a navigation system and/or the predictive routes with the destination positions being presented simultaneously.

2. The method of claim 1, wherein the current local position is ascertained continuously, with the destination position and/or routes being continuously tracked on the basis of the change in the local position.

3. The method of claim 1, wherein the stored driving information from the past has intermediate destinations that are taken into account for computing the predictive route or routes.

4. The method of claim 1, wherein current traffic reports are associated with a possible destination position and/or predictive route.

5. The method of claim 1, wherein an alternative route to a destination is computed or computation is offered.

6. The method of claim 1, wherein the routes and/or alternative routes are computed taking into account set and/or previously stored driver preferences.

7. A navigation system for providing predictive destination positions and/or predictive routes for reaching a destination position, the navigation system comprising:
a computation unit having a database,
a display unit,
means for capturing a local position, and
a memory having driver information from the past,
wherein the navigation system ascertains the current local position and the destination position is automatically derived according to probability aspects on the basis of a comparison between the stored driving information from the past and current driving information, and
wherein the navigation system ascertains n possible destination positions, where n≧2, with the destination positions being offered as an input option for the navigation system and/or the predictive routes with the destination positions being presented simultaneously on the display unit.

8. The navigation system of claim 7, wherein the navigation system continuously ascertains the current local position, with the destination positions and/or routes being continuously tracked on the basis of the local position.

9. The navigation system of claim 7, wherein the stored driving information from the past has intermediate destinations, with the navigation system takes into account the intermediate destinations for computing the predictive route or routes.

10. The navigation system of claim 7, wherein the navigation system associates current traffic reports with a possible destination position and/or predictive route.
